(19) United States
(12) Patent Application Publication
(10) Pub. No.: US 2008/0184323 A1
(43) Pub. Date: Jul. 31, 2008

(54) Communication apparatus with network multimedia playback function

(75) Inventors: Zheng-Rong Zou, Nanking (CN); Yong-Kang Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/987,153

(22) Filed: Nov. 28, 2007

(30) Foreign Application Priority Data
Jan. 25, 2007 (TW) 096102783

(51) Int. Cl. H04N 7/173

(52) U.S. Cl. 725/110; 725/109

(57) ABSTRACT

A communication apparatus with a network multimedia playback function includes a network dialup module, a multimedia module and a communication exchange module. The network dialup module can receive an electronic signal from a regular telephone wire and analyze the electronic signal to obtain an analog network packet or an audio/video packet, and processes the analog network packet into a network data and sends the network data to a computer. The multimedia module receives the audio/video packet from the network dialup module, and processes the audio/video packet into an audio/video data and sends the audio/video data to a display apparatus. The communication exchange module is provided with a voice splitter that analyzes the electronic signal to obtain a voice signal of low frequency and sends it to the communication exchange module. Thus, the communication apparatus provides the functions of a network connection, a multimedia playback, and a dialing of Internet phone.

### FIELD OF THE INVENTION

The present invention relates to a communication apparatus with network multimedia playback function, and more particularly to a communication apparatus integrating a network dialup module, a communication exchange module, and a multimedia module to achieve the functions of a network connection, a multimedia playback, and a dialing of Internet phone.

### BACKGROUND OF THE INVENTION

Presently, the network of so-called personal handy-phone system (PHS) has several disadvantages, such as incomplete communication coverage and poor signal quality. Especially, the PHS can only provide limited and weaker signal in an indoor environment. For this reason, if the PHS can be strengthened via an immobile network in the indoor environment for communicating, the communication quality of the PHS will be enhanced and the dead phone ratio will be reduced. Furthermore, in view of users' habits of PHS mobile phones, most of communication cases occur in the indoor environment. For example, houses and offices are the most frequent communication places. Thus, if communication needs in the most frequent communication places can be satisfied, the market share of the PHS can be increased.

As described above, related manufacturers develop a telephone adapter, such as so-called Home-Box, by which a PHS mobile phone can be connected to a PHS network or an immobile network in the indoor environment. If the PHS mobile phone is simultaneously within a communication coverage range of the PHS network and the immobile network of the telephone adapter, the PHS mobile phone will be switched into a dual standby mode, and the telephone adapter sets the immobile network as a preferential communication network, (i.e. the PHS mobile phone will transmit or receive a phone call by preferentially linking to the immobile network within the coverage range of the telephone adapter.) The PHS mobile phone is linked to the immobile network via the telephone adapter, so that the disadvantages of the mobile phone in the indoor environment, such as incomplete communication coverage and poor signal quality; can be substantially improved by the immobile network.

Furthermore, based on technological advances of telecommunication network, so-called Internet protocol television (IPTV) integrated with a plurality of technologies, such as multimedia and communication, is developed, wherein the IPTV uses a wide-band telecommunication network as a transmission channel, and uses televisions or computers as terminals. Thus, the IPTV can be used to provide a plurality of interactive digital multimedia services including general television contents, so as to carry out several functions, such as the reception of request audio/video programs and the broadcast of the audio/video programs. As a result, by means of widespread wide-band services, such as ADSL or cable modem, most of consumers can use the newest digital television program or broadcast.

However, if the consumers want to simultaneously use the telephone adapter and the IPTV, the consumers must buy a signal equipment of the IPTV in addition to the telephone adapter, which increases the purchase cost and considerably reduces the consumption possibility of the consumers. Therefore, if the telephone adapter and the IPTV can be integrated into a unit, the purchase cost will be reduced and related indoor cable peripherals will be simplified, so that the consumption possibility of the consumers will be increased.

It is therefore tried by the inventor to develop a communication apparatus with a network multimedia playback function to solve the problems existing in the conventional telephone adapter and the conventional IPTV, both of which are separately installed and purchased for simultaneously providing the telephone switch function and the digital television function, but there are several shortcomings, such as higher purchase cost of two equipments and more complicated cable peripherals, as described above.

### SUMMARY OF THE INVENTION

One objective of the present invention is to provide a communication apparatus with a network multimedia playback function, which includes a network dialup module, a communication exchange module, and a multimedia module, wherein the network dialup module can receive an electronic signal from a regular telephone wire and analyze the electronic signal to obtain an analog network packet or an audio/video packet, and then the network dialup module processes the analog network packet into a network data that is then sent to a computer; the communication exchange module is provided with a voice splitter which can receive the electronic signal including a voice signal of low frequency and analyze the electronic signal to obtain the voice signal of low frequency, such that the communication exchange module can be connected to a mobile communication apparatus outside of the communication apparatus; after the multimedia module receives the audio/video packet from the network dialup module, the multimedia module processes the audio/video packet into an audio/video data which is then sent to a display apparatus for playing the audio/video data. Thus, the communication apparatus provides the functions of a telephone dialing of “Home-Box”, a network connection of ADSL2+ Modem, and a multimedia playback of IPTV audio/video decoding, so as to increase potential customers for telecommunication providers and to enhance the usage convenience of the communication apparatus.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a communication apparatus with a network multimedia playback function according to a preferred embodiment of the present invention; and

FIG. 2 is a detailed block diagram of a communication apparatus with a network multimedia playback function according to the preferred embodiment of the present invention, similar to FIG. 1.

### DETAILED DESCRIPTION OF THE PREFERRED EMBODIMENTS

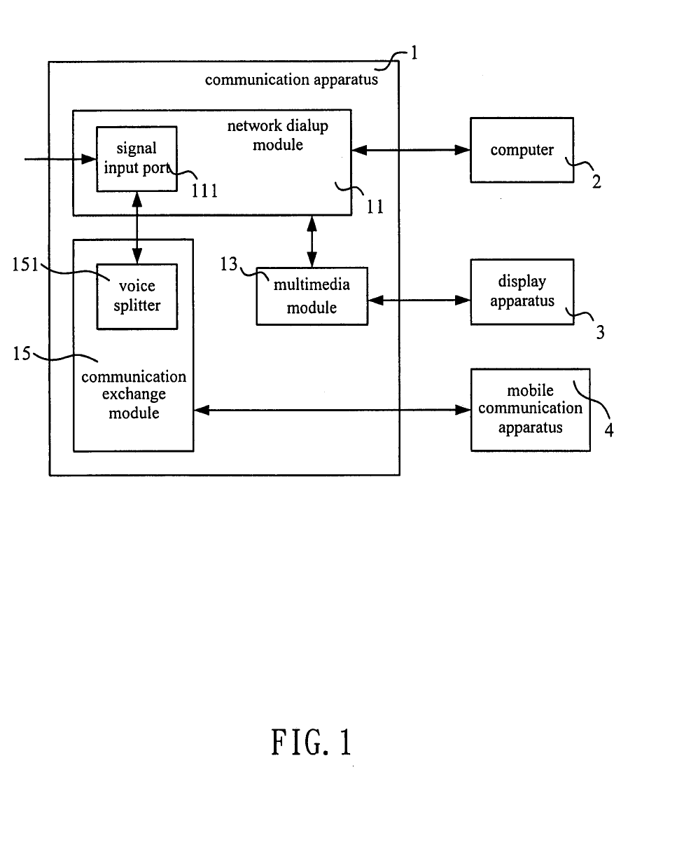

Referring now to FIG. 1, a communication apparatus with a network multimedia playback function according to a preferred embodiment of the present invention is illustrated. As shown, the communication apparatus designated by numeral 1 comprises a network dialup module 11, a multimedia module 13, and a communication exchange module 15, wherein the network dialup module 11 (such as an ADSL2+ Modem) is electrically connected to the communication exchange module 15 (also called Home-Box, such as private automatic branch exchange, PABX) and the multimedia module 13 (such as an Internet protocol television, IPTV), respectively. Furthermore, the network dialup module 11 is provided with a signal input port 111 (such as RJ-11 telephone cable connector), which is linked to an Internet via a core equipment (such as a digital subscriber line access multiplexer, DISLAM) for receiving an electronic signal. When the electronic signal is transmitted to the network dialup module 11, the network dialup module 11 will analyze the electronic signal to obtain an analog network packet or an audio/video packet, and then the network dialup module 11 will process the analog network packet into a network data which is then sent to a computer 2 outside the network dialup module 11, so that the computer 2 can link to the Internet via the network dialup module 11. When the multimedia module 13 receives the audio/video packet from the network dialup module 11, the multimedia module 13 will process the audio/video packet into an audio/video data that is then sent to a display apparatus 3 (such as a television) connected to the multimedia module 13 for playing the audio/video data. The communication exchange module 15 is provided with a voice splitter 151 (such as a low-pass filter) therein, wherein the voice splitter 151 can receive an electronic signal including a voice signal of low frequency and analyze the electronic signal to obtain the voice signal of low frequency, such that the communication exchange module 15 can be connected to a mobile communication apparatus 4 (such as a PHS mobile phone) outside of the communication apparatus 1 for wirelessly dialing.

As a result, the network dialup module 11, the multimedia module 13, and the communication exchange module 15 are integrated into a unit, i.e. the communication apparatus 1, wherein the voice splitter 151 is used to separate the voice signal, the analog network packet, and the audio/video packet without interfering with each other, so that the network dialup module 11 can be used to link to the Internet, the multimedia module 13 can be used to play the audio/video data, and the communication exchange module 15 can be used to dial via the Internet. Thus, the usage convenience of the communication apparatus 1 will be enhanced for general consumers, and potential customers for telecommunication providers will be increased.

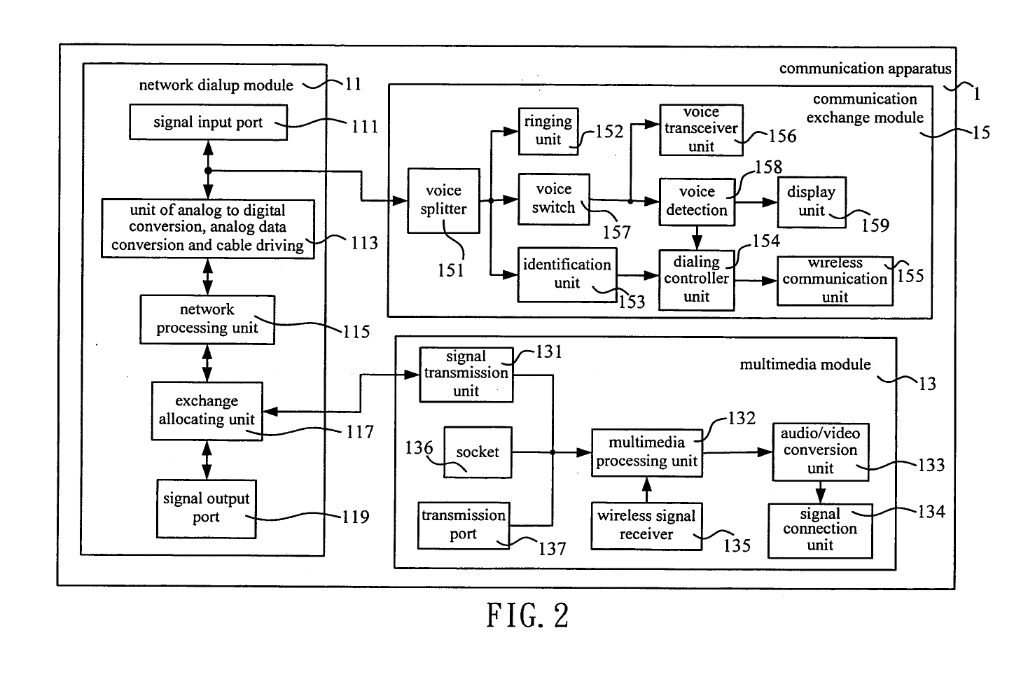

Referring now to FIGS. 1 and 2, in the preferred embodiment of the present invention, the network dialup module 11 is preferably selected from a router modem which is used to allocate dynamic IP addresses (such as dynamic host configuration protocol, DHCP) to the computer 2 and the multimedia module 13. The network dialup module 11 is further provided with a unit 113 of analog to digital conversion, analog data conversion and cable driving, a network processing unit 115, an exchange allocating unit 117, and a signal output port 119. The unit 113 of analog to digital conversion, analog data conversion and cable driving is preferably selected from a BAZ-3882-NCAZ chip, and is electrically connected to the signal input port 111. The unit 113 of analog to digital conversion, analog data conversion and cable driving can be used to receive the analog network packet, and then convert the analog network packet into a digital network packet, while the unit 113 can also be used to receive the audio/video packet, and then convert the audio/video packet by a analog to digital conversion. The network processing unit 115 is preferably selected from a GSBV120-174-004DBOEZ chip, and is electrically connected to the unit 113 of analog to digital conversion, analog data conversion, and cable driving. The network processing unit 115 can be used to receive the digital network packet, and then decode the digital network packet into the network data. The exchange allocating unit 117 is preferably selected from an exchange type DM8606AF high-speed Ethernet chip, and is electrically connected to the network processing unit 115. The exchange allocating unit 117 can be used to receive the network data, and send the network data to the computer 2. The exchange allocating unit 117 can also be used to receive the audio/video packet converted by the analog to digital conversion, and then send the converted audio/video packet to the multimedia module 13.

Moreover, the signal output port 119 is preferably selected from a RJ45 network cable connector, and is electrically connected to the exchange allocating unit 117 and the computer 2, respectively. The signal output port 119 can be used to receive the network data, and send the network data to the computer 2 for linking to the Internet. As a result, the communication apparatus is linked to the Internet via the network dialup module 11, so that the received analog network packet is converted into the network data that is used to link to the computer 2, in order to construct a local area network (LAN). On the other hand, the network dialup module 11 is electrically connected to the multimedia module 13, so that the multimedia module 13 is linked to the LAN.

Referring still to FIGS. 1 and 2, in the preferred embodiment of the present invention, the multimedia module 13 is preferably selected from an Internet protocol television (IPTV), and is provided with a signal transmission unit 131, a multimedia processing unit 132, an audio/video conversion unit 133, and a signal connection unit 134. The signal transmission unit 131 is preferably selected from a RTL8100B high-speed Ethernet controller chip with a PCI bus interface, and is electrically connected to the exchange allocating unit 117. The signal transmission unit 131 can be used to receive the audio/video packet converted by the analog to digital conversion, and then decode the converted audio/video packet into the audio/video data. The multimedia processing unit 132 is preferably selected from an EM8622L decoding chip with a H.264 and VC-1 decoding function, and is electrically connected to the signal transmission unit 131. The multimedia processing unit 132 can be used to receive the audio/video data and process the audio/video data by a playing process. The audio/video conversion unit 133 is preferably selected from a high-definition multimedia interface transmit (HDMI Transmit) and an audio digital analog converter (Audio DAC), and is electrically connected to the multimedia processing unit 132. The audio/video conversion unit 133 can be used to receive the processed audio/video data, and convert the processed audio/video data by a bandwidth conversion followed by sending the processed and converted audio/video data to the display apparatus 3. The signal connection unit 134 is preferably selected from a high-definition multimedia interface (HDMI), an AV Composite interface, a S-Video interface, an interface of high-definition video signal YPbPr, a SPDIF interface, and a general L/R audio output interface, while the signal connection unit 134 is electrically connected to the audio/video conversion unit 133 and the display apparatus 3, respectively. The signal connection unit 134 can be used to send the processed and converted audio/video data to the display apparatus 3 for playing.

If the display apparatus 3 is selected from a digital television, the display apparatus 3 can be connected to the audio/video conversion unit 133 for receiving the audio/video data, so that the display apparatus 3 (i.e. the digital television) can display in a high-definition display mode, such as a 720P mode, a 1080I mode, and a 1080P mode. If the display apparatus 3 is selected from an analog television, the display apparatus 3 can also be connected to the audio/video conversion unit 133 for receiving the audio/video data, so that the display apparatus 3 (i.e. the analog television) can display the audio/video data in an analog display mode. As a result, the exchange allocating unit 117 and the signal transmission unit 131 are connected to each other for automatically adjusting the bandwidth, and the signal transmission unit 131 obtains a desired bandwidth of playing the audio/video data by the display apparatus 3 after the audio/video packet is processed by the playing process and the bandwidth conversion in a transmission speed of 10/100 Mbit/sec by the high-speed Ethernet exchange technology. Moreover, the multimedia module 13 has a receiving and playing speed which is preferably selected from several bandwidth-speeds, such as 2 Mbps, 4 Mbps, and etc., so that the multimedia module 13 and the computer 2 can simultaneously link to the network without lowering the quality of service (QOS), such as network flow, linking rate, linking priority, and etc.

Referring back to FIG. 2, in the preferred embodiment of the present invention, the multimedia module 13 is further provided with a wireless signal receiver 135, a socket 136, and a transmission port 137. The wireless signal receiver 135 is preferably selected from an infrared receiver, and is electrically connected to the multimedia processing unit 132. The wireless signal receiver 135 can be used to receive a wireless signal transmitted from a remote controller (not shown), and then send the wireless signal to the multimedia processing unit 132, so that the multimedia processing unit 132 will receive a command in the wireless signal from the remote controller for selecting channels, adjusting sound volume, and etc. The socket 136 is preferably selected from a Mini PCI bus, and is electrically connected to the signal transmission unit 131 and the multimedia processing unit 132, respectively. The socket 136 can be connected to an external wireless network card of 802.11b/g (not shown). After the wireless network card receives a wireless network packet, the wireless network packet is passed through the socket 136 and transmitted to the signal transmission unit 131, so that the signal transmission unit 131 will decode the wireless network packet into the audio/video data which is then sent to the multimedia processing unit 132 for processing the audio/video data by the playing process.

In addition, the transmission port 137 is preferably selected from a USB connection port, and is electrically connected to the multimedia processing unit 132 and an external USB storage device (not shown). The transmission port 137 can be used to receive an audio/video data procedure of the USB storage device, which is transmitted to the multimedia processing unit 132, so that the multimedia processing unit 132 will receive the audio/video data procedure for processing the audio/video data procedure by the playing process. As a result, the wireless signal receiver 135, the socket 136, and the transmission port 137 can be used to increase the usage convenience of the multimedia module 13, and it will be easy to connect the communication apparatus 1 to other external devices with different specifications for enhancing the practicability thereof.

Referring back to FIGS. 1 and 2, in the preferred embodiment of the present invention, the communication exchange module 15 is further provided with a ringing unit 152, an identification unit 153, a dialing controller unit 154, and a wireless communication unit 155. The ringing unit 152 is preferably selected from a LS1240A chip, and is electrically connected to the voice splitter 151. The ringing unit 152 can be used to receive the voice signal of low frequency, so that the ringing unit 152 will generate a phone call ringing. The identification unit 153 is preferably selected from a HT9032D caller identification chip and HT9170D demodulation chip, and is electrically connected to the voice splitter 151 and the ringing unit 152, respectively. The identification unit 153 can be used to receive the voice signal of low frequency. Furthermore, the identification unit 153 has functions of double tone multi-frequency (DTMF) function and frequency shift keying (FSK), so that the identification unit 153 can be used to receive DTMF/FSK caller phone numbers and analyze the voice signal of low frequency to obtain a caller information, such as caller phone numbers.

Moreover, the dialing controller unit 154 is preferably selected from a W742S81A microcontroller chip, and is electrically connected to the identification unit 153. The dialing controller unit 154 is a 4-bit microcontroller (MCU) applied to telephones, and has functions of double tone multi-frequency dialing (DTMF dialing) and LCD driver. The dialing controller unit 154 can be used to receive the caller information for generating a caller signal. The wireless communication unit 155 is electrically connected to the dialing controller unit 154, and is used to receive the caller signal. The wireless communication unit 155 is preferably selected from a combination of a PHS Baseband chip and a PHS RF chip, so as to process the voice signal of low frequency by a RF process and then send the processed voice signal of low frequency to a predetermined range outside of the communication apparatus 1, such that the mobile communication apparatus 4 within the predetermined range can link to the communication apparatus 1 via the wireless communication unit 155.

Referring still to FIGS. 1 and 2, in the preferred embodiment of the present invention, the communication exchange module 15 is further provided with a voice transceiver unit 156, a voice switch 157, a voice detection unit 158, and a display unit 159. The voice transceiver unit 156 is preferably selected from a FM34018 voice-controlled speaker dialing chip and a UTC1062 voice transmission chip. The voice transceiver unit 156 can be used to receive the voice signal of low frequency for outputting or inputting a voice. The voice switch 157 is mounted between the voice splitter 151 and the voice transceiver unit 156. When the voice switch 157 is switched on, the voice signal of low frequency is sent to the voice transceiver unit 156. The voice detection unit 158 is electrically connected to the dialing controller unit 154, the voice transceiver unit 156, and the voice switch 157, respectively, and can be used to generate a display signal. The display unit 159 is electrically connected to the voice detection unit 158, and can be used to receive the display signal for displaying a dialing status.

When the voice splitter 151 separates the voice and the network modulated information transmission of the electronic signal, the electronic signal will be separated into the analog network packet, the audio/video packet, and the voice signal of low frequency, wherein the analog network packet and the audio/video packet are sent to the network dialup module 11, and the voice signal of low frequency is sent to the communication exchange module 15, so as to maintain the communication quality of the communication exchange module 15 and the network linking quality of the network dialup module 11. Even though the mobile communication apparatus 4 is away from a predetermined range (such as 300 meters) of the wireless communication unit 155, the mobile communication apparatus 4 can still receive the voice signal of low frequency (such as RF), so as to link to the wireless communication unit 155 for a communication purpose. Furthermore, the voice splitter 151 is used to carry out a high-speed data transmission via a high frequency area of a regular telephone wire without affecting the transmission of the voice signal of low frequency, wherein the foregoing high-speed data transmission uses asymmetric data, so that the communication download speed of the high-speed data transmission can be ranged between 8 Mbps and 24 Mbps, and the communication upload speed thereof can be 1 Mbps.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A communication apparatus with a network multimedia playback function, comprising:
a network dialup module for receiving an electronic signal and analyzing the electronic signal to obtain an analog network packet or an audio/video packet, wherein the analog network packet is processed into a network data which is sent to a computer connected to the network dialup module;
a multimedia module for receiving the audio/video packet from the network dialup module and processing the audio/video packet into an audio/video data which is sent to a display apparatus connected to the multimedia module for playing the audio/video data; and
a communication exchange module provided with a voice splitter which receives the electronic signal and analyzes the electronic signal to obtain a voice signal of low frequency, such that the communication exchange module is connected to a mobile communication apparatus outside the communication apparatus.

2. The communication apparatus with the network multimedia playback function of claim 1, wherein the network dialup module further comprises: a unit of analog to digital conversion, analog data conversion and cable driving, wherein the unit is connected to a signal input port of the network dialup module for receiving the analog network packet and converting the analog network packet into a digital network packet; and wherein the unit further receives the audio/video packet and converts the audio/video packet by a analog to digital conversion;
a network processing unit connected to the unit of analog to digital conversion, analog data conversion and cable driving, wherein the network processing unit receives the digital network packet and decodes the digital network packet into the network data; and
an exchange allocating unit connected to the network processing unit, wherein the exchange allocating unit receives the network data and sends the network data to the computer; and wherein the exchange allocating unit further receives the audio/video packet converted by the analog to digital conversion and sends the converted audio/video packet to the multimedia module.

3. The communication apparatus with the network multimedia playback function of claim 2, wherein the network dialup module further comprises a signal output port which is electrically connected to the exchange allocating unit and the computer, respectively; and wherein the signal output port receives the network data and sends the network data to the computer.

4. The communication apparatus with the network multimedia playback function of claim 2, wherein the multimedia module further comprises:
a signal transmission unit connected to the exchange allocating unit, wherein the signal transmission unit receives the audio/video packet converted by the analog to digital conversion and decodes the converted audio/video packet into the audio/video data;
a multimedia processing unit connected to the signal transmission unit, wherein the multimedia processing unit receives the audio/video data and processes the audio/video data by a playing process; and
an audio/video conversion unit connected to the multimedia processing unit, wherein the audio/video conversion unit receives the processed audio/video data, converts the processed audio/video data by a bandwidth conversion, and sends the processed and converted audio/video data to the display apparatus.

5. The communication apparatus with the network multimedia playback function of claim 4, wherein the multimedia module further comprises a signal connection unit which is electrically connected to the audio/video conversion unit and the display apparatus, respectively; and wherein the signal connection unit sends the processed and converted audio/video data to the display apparatus.

6. The communication apparatus with the network multimedia playback function of claim 5, wherein the communication exchange module further comprises:
a ringing unit connected to the voice splitter for receiving the voice signal of low frequency;
an identification unit connected to the voice splitter and the ringing unit, respectively, wherein the identification unit receives the voice signal of low frequency and analyzes the voice signal of low frequency to obtain a caller information;
a dialing controller unit connected to the identification unit for receiving the caller information, so as to generate a caller signal; and
a wireless communication unit connected to the dialing controller unit for receiving the caller signal, processing the voice signal of low frequency by a RF process, and sending the processed voice signal of low frequency out of the communication apparatus.

7. The communication apparatus with the network multimedia playback function of claim 6, wherein the communication exchange module further comprises:
a voice transceiver unit for receiving the voice signal of low frequency in order to output or input a voice;
a voice switch mounted between the voice splitter and the voice transceiver unit, wherein when the voice switch is switched on, the voice signal of low frequency is sent to the voice transceiver unit;
a voice detection unit connected to the voice transceiver unit, the dialing controller unit, and the voice switch, respectively, wherein the voice detection unit generates a display signal; and
a display unit connected to the voice detection unit for receiving the display signal.

8. The communication apparatus with the network multimedia playback function of claim 5, wherein the multimedia module further comprises:
a socket connected to the signal transmission unit and the multimedia processing unit, respectively, wherein the socket receives a wireless network packet which is passed through the socket and transmitted to the signal transmission unit; and
a transmission port connected to the multimedia processing unit for receiving an audio/video data procedure which is transmitted to the multimedia processing unit.

9. The communication apparatus with the network multimedia playback function of claim 8, wherein the multimedia module further comprises a wireless signal receiver connected to the multimedia processing unit for receiving a wireless signal which is sent to the multimedia processing unit

10. The communication apparatus with the network multimedia playback function of claim 8, wherein the socket is a Mini PCI bus connected to a wireless network card.

11. The communication apparatus with the network multimedia playback function of claim 8, wherein the transmission port is a USB connection port.

12. The communication apparatus with the network multimedia playback function of claim 9, wherein the wireless signal receiver is an infrared receiver.
